(19) United States
(12) Patent Application Publication
(10) Pub. No.: US 2014/0124299 A1
(43) Pub. Date: May 8, 2014

(54) ELECTRO-HYDRAULIC ACTUATOR (EHA) FOR PALLET TRUCK

(71) Applicant: Parker-Hannifin Corporation, Cleveland, OH (US)

(72) Inventor: Matthew C. Royer, Dayton, MN (US)

(73) Assignee: Parker-Hannifin Corporation, Cleveland, OH (US)

(21) Appl. No.: 14/069,990

(22) Filed: Nov. 1, 2013

Related U.S. Application Data
(60) Provisional application No. 61/721,415, filed on Nov. 1, 2012.

(51) Int. Cl. B66F 9/22; F15B 15/26; F15B 15/22; F15B 11/00; F15B 13/01

(52) U.S. Cl. CPC B66F 9/22; F15B 11/003; F15B 13/015; F15B 15/22; F15B 15/26
USPC 187/234; 60/442; 60/459; 91/388; 91/410

(57) ABSTRACT

An improvement to the component based hydraulic systems is an integrated electro-hydraulic actuator (EHA) that contains all components necessary to achieve power up, gravity return actuation of a lift mechanism such as the forks of a pallet truck. Further, improvements to known power-up, gravity-down component-based hydraulic circuits are described herein. The improvements provide for power up, gravity return functionality with fewer components as compared known systems. Finally, a method for controlling the EHA and/or hydraulic circuits described above is detailed herein and provides a user with maximum control of a lift mechanism during lower or “down mode,” but also provides for the least amount of energy consumption by the actuator.

### FIELD OF INVENTION

The present invention relates generally to electro-hydraulic actuators, and more particularly to electro-hydraulic actuators for use with lifting mechanisms.

### BACKGROUND

Vehicles such as pallet trucks typically use component-based hydraulic systems to power their lift mechanisms. These systems can be power-up and power-down systems, but are usually power-up and gravity-down systems. In either case, component based systems are bulky and require assembly and plumbing for their installation.

### SUMMARY OF INVENTION

An improvement to the component based hydraulic systems is a one piece Electro-Hydraulic Actuator (EHA) that contains all components necessary to achieve power up, gravity return actuation of a lift mechanism such as the forks of a pallet truck. The self-contained EHA eliminates labor associated with assembly and plumbing of traditional, component-based hydraulic systems (i.e.

external power unit, cylinder, hoses, fittings, etc.). The compact size of an EHA also minimizes the space claim of the vehicle actuator, allowing vehicle original equipment manufacturers to capitalize on space left vacant by larger component-based hydraulic systems. This additional space could be used to increase the vehicle battery bank—thereby increasing vehicle run time—or to reduce the overall footprint of the vehicle to improve vehicle mobility. This increased mobility may be especially important in pallet trucks working in, for example, a warehouse, where smaller size and greater mobility can increase vehicle safety and may allow for denser storage of warehouse goods.

Further, improvements to conventional power-up, gravity-down component-based hydraulic circuits are described herein. The improvements provide for power up, gravity return functionality with fewer components as compared with conventional systems.

Finally, a method for controlling the EHA and/or hydraulic circuits described above is detailed herein and provides a user with maximum control of a lift mechanism during lower or “down mode,” but also provides for the least amount of energy consumption by the actuator.

According to one aspect of the invention, a hydraulic circuit having an up mode, a static mode, and a down mode includes a pilot-operated load holding check valve positioned between an up side of a hydraulic pump and a first side of a hydraulic actuator, whereby the pilot-operated load holding check valve hydraulically locks the actuator, preventing movement of the actuator by an external load when the circuit is in the static mode; an orifice positioned between a down side of the hydraulic pump and a reservoir, whereby the orifice generates signal pressure upstream of the orifice to unseat the pilot-operated load holding check valve when the circuit is in the down mode; and a pilot-operated normally closed valve positioned between the pilot-operated load holding check valve and the reservoir, whereby the pilot-operated normally closed check valve allows flow of fluid from the actuator to the reservoir when the circuit is in the down mode.

Optionally, a flow control valve positioned between the actuator and the reservoir, whereby the flow control valve limits the rate at which fluid exits the actuator when the circuit is in the down mode.

Optionally, the orifice is configured to allow flow to a reservoir while maintaining sufficient pressure to pilot operate the load holding check-valve and the normally closed spool valve when the circuit is in the down mode, thereby minimizing power consumption when a motor powering the circuit is run continually during the down mode.

Optionally, the hydraulic circuit includes a fluid passageway, and the actuator is a cylinder having a rod side and a piston side, the fluid passageway connecting a rod-side of the cylinder to a fluid reservoir, whereby excess hydraulic fluid of the circuit is stored in the rod-side of the cylinder.

Optionally, the hydraulic circuit includes a second pilot-operated check valve having an inlet and an outlet, the inlet being fluidly connected between the down side of the pump and the orifice, the outlet being fluidly connected to a pilot portion of the pilot-operated load holding check valve and to a pilot portion of the pilot-operated normally closed valve, whereby the second pilot-operated check valve allows the load holding check valve to remain open without continuous power from a motor during the down mode.

Optionally, the hydraulic circuit includes a preventer valve fluidly connected between the spool valve and a reservoir configured to prevent flow from the reservoir to the spool valve.

Optionally, the preventer valve is a low pressure relief valve.

Optionally, the low pressure relief valve is sized such that required activation pressure is less than that generated by a minimum load on the cylinder yet sufficient to block flow back to the reservoir, thereby allowing the spool valve to return to a closed position and direct pump flow to the cylinder.

Optionally, the second pilot-operated check valve includes a pilot portion fluidly connected to an up side of the pump.

According to another aspect of the invention, a method for controlling an actuator includes hydraulically locking the actuator with a pilot-operated load holding check valve, thereby preventing movement of the actuator by an external load; generating signal pressure upstream of an orifice to unseat the pilot-operated load holding check valve; and allowing flow of fluid from the actuator to a reservoir by opening a pilot-operated normally closed valve.

Optionally, the method includes receiving a down command having a beginning and an end; pulsing a motor in a down direction in response to the beginning of the down command; and pulsing the motor in an up direction in response to the end of the down command.

Optionally, the method includes receiving an up command having a beginning and an end; continuously running the motor in the up direction between the beginning and the end of the up command.

Optionally, the method includes allowing flow to a reservoir while maintaining sufficient pressure to pilot operate the load holding check-valve and the normally closed spool valve, thereby minimizing power consumption when a motor powering the circuit is run continually during the down mode.

Optionally, the method includes storing excess hydraulic fluid in a rod side of the actuator.

Optionally, the method includes keeping pressure in a pilot portion of the pilot-operated load holding check valve and a pilot portion of the pilot-operated normally closed valve via a closed second pilot-operated check valve.

Optionally, the method includes releasing pressure from a pilot portion of the pilot-operated load holding check valve and a pilot portion of the pilot-operated normally closed valve by opening a second pilot-operated check valve.

According to another aspect of the invention, a vehicle includes a lifting mechanism; and an integrated electro-hydraulic actuator unit including a cylinder having an output rod and a piston, a manifold, a fluid reservoir, a pump, and a motor.

Optionally, the manifold is configured for power-up, continuous gravity-down operation of the cylinder.

Optionally, the manifold is configured for power-up, momentary gravity-down operation of the cylinder.

Optionally, the manifold includes a hydraulic circuit having a pilot-operated load holding check valve positioned between an up side of the pump and a first side of a hydraulic actuator, whereby the pilot-operated load holding check valve hydraulically locks the actuator, preventing movement of the actuator by an external load when the circuit is in the static mode; an orifice positioned between a down side of the hydraulic pump and a reservoir, whereby the orifice generates signal pressure upstream of the orifice to unseat the pilot-operated load holding check valve when the circuit is in the down mode; and a pilot-operated normally closed valve positioned between the pilot-operated load holding check valve and the reservoir, whereby the pilot-operated normally closed check valve allows flow of fluid from the actuator to the reservoir when the circuit is in the down mode.

Optionally, the vehicle further includes a controller configured to perform the method having the steps of receiving a down command having a beginning and an end; pulsing a motor in a down direction in response to the beginning of the down command; and pulsing the motor in an up direction in response to the end of the down command.

The foregoing and other features of the invention are hereinafter described in greater detail with reference to the accompanying drawings.

### BRIEF DESCRIPTION OF THE DRAWINGS

FIG. 1 shows a perspective view of an exemplary electro-hydraulic actuator (EHA) with portions of the housing shown in broken lines allowing a view of interior components.

FIG. 2 shows a reverse detailed view of the exemplary EHA of FIG. 1.

FIG. 3 shows an exemplary power up, continuous gravity down hydraulic circuit in accordance with aspects of the present invention.

FIG. 4 shows an exemplary power up, momentary gravity down hydraulic circuit in accordance with aspects of the present invention.

FIG. 5 shows a block diagram showing an exemplary method of controlling an exemplary EHA in accordance with aspects of the present invention.

### DETAILED DESCRIPTION

Although described herein with relation to a pallet-truck for brevity and convenience of understanding, the present invention should not be understood to be so limited. Rather, the invention is applicable to any mechanism having an externally-applied (external to the hydraulic actuator of interest) load allowing for a non-powered return (for example, a “gravity down” mode of a lift mechanism wherein gravity generates a restorative force that causes the actuator to move from an extended position to a retracted position), and can be stationary or vehicle mounted. Further, as used herein an “up mode” is understood to mean the mode or state in which pressure (e.g., when pump power pressurizes fluid) is required to move an actuator in a first direction against a load exerting a force on the actuator, and “down mode” is understood to mean the mode or state in which the actuator moves in a second direction, opposite the first direction, by the external load applied to the actuator. A “gravity down” or “gravity return” mode is a down mode in which active power by a pump is not required to move the actuator in the second direction. Rather, an external load on the actuator—for example, caused by gravity acting on the forks of a pallet lift mechanism—causes the actuator to move in the second direction, although such mode is not limited to situations in which gravity is the source of the external load. Rather, such term is used for clarity and convenience. A “continuous” gravity down mode is one in which a pump continuously provides fluid pressure to operate the hydraulic circuit to allow the external load on the actuator to move the actuator in the second direction. A “momentary” gravity down mode is one in which a pressure source (e.g., a pump) need only provide momentary pressure (or pulse) to activate the circuit mode that allows the external load on the actuator to move the actuator in the second direction. In other words, the momentary pressure or pulse acts as a way of controlling one or more components but is not used to provide motive force to an actuator. Finally, a “static mode” is a mode in which the hydraulic circuit locks the actuator in place without continuous pump power.

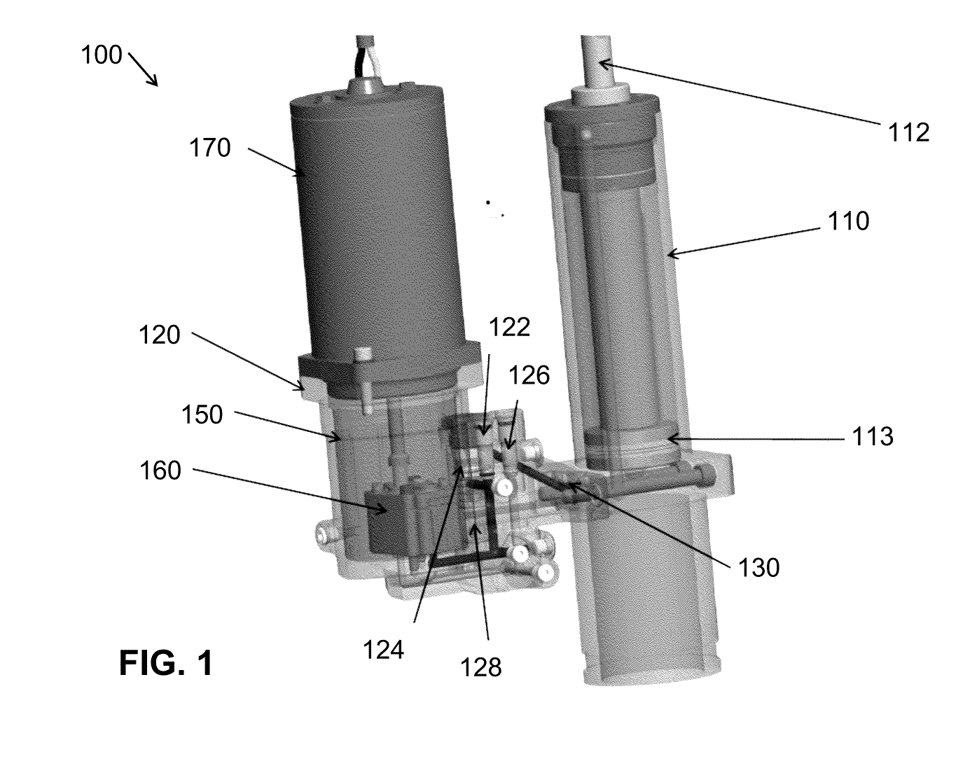

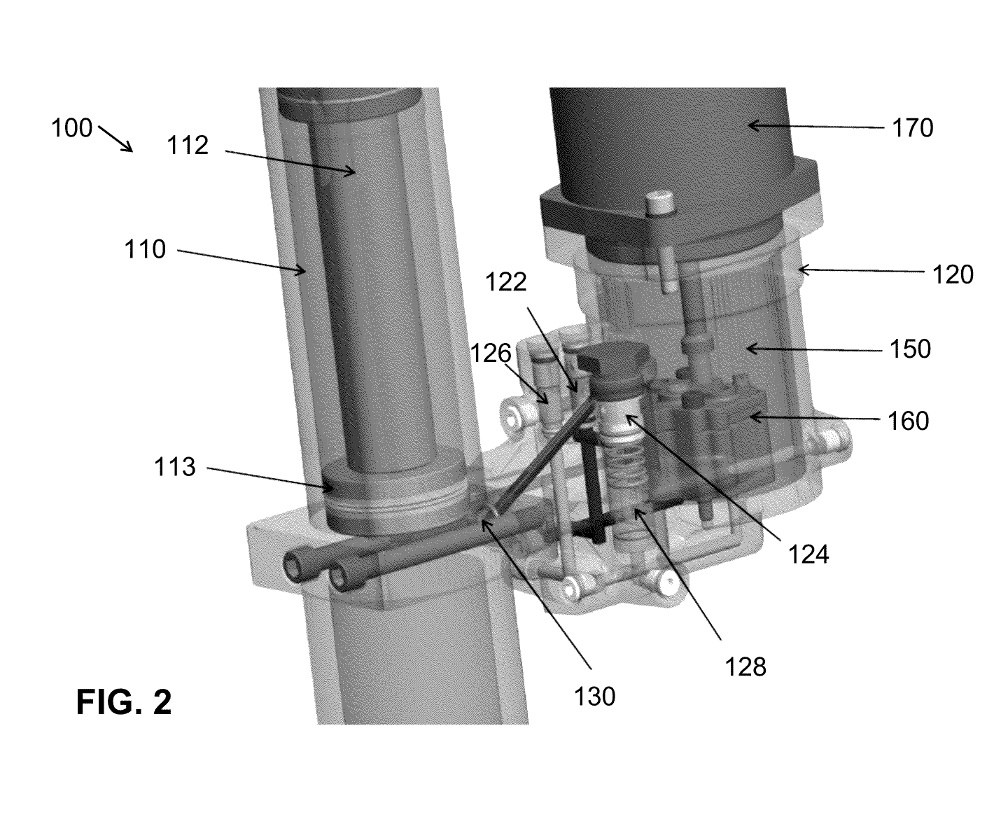

An integrated, self-contained electro-hydraulic actuator (EHA) unit 100 as shown in FIGS. 1 and 2 contains the hydraulic components to achieve power up, gravity return actuation of the forks of a pallet truck. Components in the EHA may include a cylinder 110 having a rod 112 and a piston 113, a manifold 120, a fluid reservoir 150, a pump 160, and a motor 170. The self-contained EHA eliminates labor associated with assembly and plumbing of traditional, component-based hydraulic systems (i.e. external power unit, cylinder, hoses, fittings, etc.). The compact size of EHA also minimizes the space claim of the pallet truck actuator, allowing pallet truck original equipment manufacturers to capitalize on space left vacant by larger component-based hydraulic systems. This additional space could be used to increase the truck battery bank—thereby increasing vehicle run time—or to reduce the overall footprint of the pallet truck to improve vehicle mobility.

Other features which may be included in exemplary EHAs are described in more detail in U.S. patent application Ser. No. 13/234,609, filed Sep. 16, 2011, the disclosure of which is hereby incorporated herein by reference.

As illustrated, the manifold 120 includes a hydraulic circuit which may include all of the valving for controlling the EHA. Possible configurations of the valving are described below in detail and are shown here with similar numerals but indexed by 100. The manifold 120 may be of one piece with the reservoir 150. The reservoir 150 may enclose the pump 160, thereby submerging the pump in hydraulic fluid. The manifold 120 may include a motor mounting face at a top edge of the reservoir 150 which may be connectable (e.g., by one or more bolts or screws) to the motor 170. The manifold 120 may include a side actuator mounting face which may be connectable (e.g., by one or more bolts or screws) to the cylinder 110. Alternatively, the manifold may be formed of one piece with the outer casing of the cylinder 110.

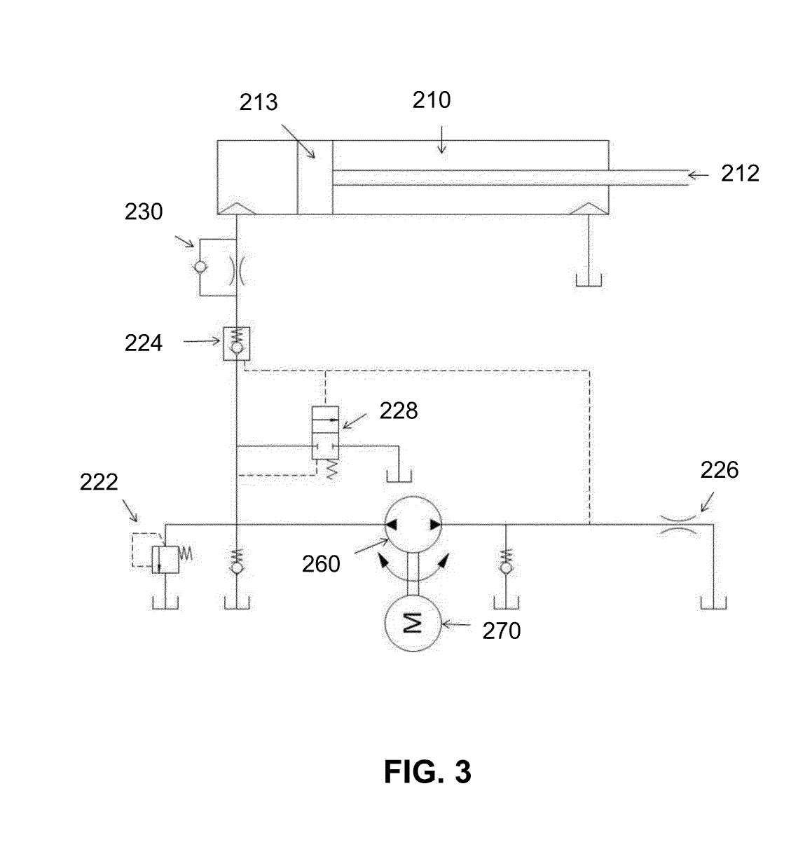

Referring now to FIG. 3 a hydraulic circuit 200 is shown which provides for power up, gravity return functionality with fewer components as compared to conventional circuits. Operated in the “up” direction, the motor 270 drives a pump 260 (which may be submerged as depicted in FIGS. 1 and 2) and delivers hydraulic oil to the cylinder 210, building adequate pressure to move the piston 213 against the external load seen by the circuit (e.g., gravity pulling on the forks of a pallet truck).

A relief valve 222 may be included to limit pressure delivered to the cylinder to prevent against generating excess loads.

Stopping the motor 270 ceases flow of fluid into the cylinder 210 and a pilot-operated load holding check valve 224 hydraulically locks the piston 213, preventing movement of the rod 212 against the external load of the circuit.

Returning the actuator (e.g., pallet truck forks via gravity) to the “down” position is accomplished by operating the motor 270 in the “down” direction, driving the pump 260 and producing flow to an orifice 226. Flow through the orifice 246 generates signal pressure upstream of the orifice which unseats the pilot-operated load holding check 224. The load holding check 224 is held open as long as the motor 270 is run, facilitating the flow of fluid from the cylinder 210 back to the reservoir 250 via a pilot-operated normally closed valve 228 (which may be a spool valve) allowing the piston 213 and rod 212 to retract and lower the forks of the pallet truck.

A flow control valve 230 may be included to limit the rate at which fluid exits the cylinder during the lowering cycle ensuring a controlled decent.

Once the motor 270 is stopped, pilot pressure is lost without flow through the orifice 226, allowing the load holding check 224 to reseat and hydraulically lock the piston 213 to prevent further lowering of the pallet truck forks.

The orifice 226 is sized such that flow through the orifice generates sufficient pressure to pilot operate the load holding check 224 and the normally-closed valve 228 while ensuring that the resultant pressure drop minimizes power consumption while the motor is run continually throughout the lowering cycle.

The cylinder 210 may be selected so as to minimize rod size, and the rod-side of the cylinder 210 may be connected directly to the fluid reservoir 250 to allow for additional oil volume to be stored therein, effectively reducing the footprint of the actuator solution by minimizing the size of the fluid reservoir 250.

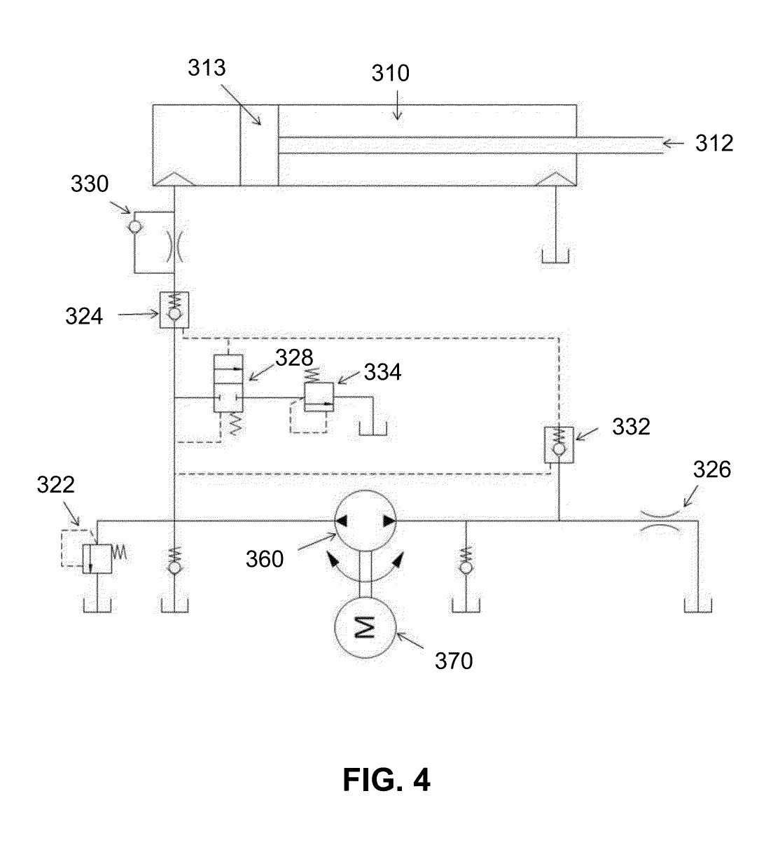

A second exemplary hydraulic circuit 300 is shown in FIG. 4. The hydraulic circuit 300 is substantially the same as the above-referenced hydraulic circuit 200, and consequently the same reference numerals but indexed by 100 are used to denote structures corresponding to similar structures in the hydraulic circuit. In addition, the foregoing description of the hydraulic circuit 200 is equally applicable to the hydraulic circuit 300 except as noted below.

The hydraulic circuit 300 includes a second pilot-operated check valve 332 incorporated into the signal line upstream of the orifice 326. The presence of the pilot line check valve 332 allows the load holding check 324 to remain open without the need to run the motor 370 continuously during the lowering cycle. In this way, the motor 370 would only have to be pulsed in the reverse direction to generate flow through the orifice 326 and build pressure to activate the pilot operated load holding check 324 and normally closed valve 328. Once the motor 370 is shut off, the pilot line check valve 332 closes and maintains pressure to keep the load holding check 324 unseated and fluid from the cylinder flowing through the activated normally closed valve 328 and low pressure relief valve 334, thereby allowing the cylinder to retract under the load of the pallet truck until the forks reach the ground. Once the motor 370 is run in the “up” direction, flow through the pilot operated normally closed valve 328 is restricted by the low pressure relief valve 334, returning the normally closed valve 328 to the closed position via pilot pressure and directing flow from the pump 360 back into the cylinder 310. The low pressure relief valve 334 is sized such that the required activation pressure is less than that generated by the minimum load on the pallet truck forks yet sufficient to block flow back to the reservoir allowing the pilot operated normally closed valve 328 to return to the closed position and direct pump flow to the cylinder 310.

The previously described embodiments detail gravity return functions that require either momentary or continuous input to the EHA in order for the forks of a pallet truck to be lowered.

The first embodiment describes a solution whereby the gravity return functionality is continuous. That is, the pump (for example, via motor 270) must be continuously run in the “down” direction in the absence of the pilot line check valve 332 to maintain adequate pressure to keep the pilot operated valve active and lower the forks of the pallet truck. Once input is removed, pressure is lost through the orifice 226 and the pump 260 causing the load holding check 224 to seat, thereby hydraulically locking the piston. This embodiment may be a preferred solution from a safety standpoint as it offers the user comparatively more control during the lowering cycle, but it is the solution which consumes relatively high amounts of energy because the pump must be continuously run during the down mode.

The second embodiment describes a solution whereby the gravity return functionality of the system requires momentary pressure. That is, if the pump (typically via motor 370) is pulsed in the “down” direction, the forks of the pallet truck will continue to lower as pressure in the pilot line is maintained by the check valve 332 holding the load holding check 324 open and allowing the forks to fully lower without further input to the system. This embodiment is a preferred approach from a power consumption perspective since the pump is not run continuously throughout the lowering cycle, but it offers a comparatively lower degree of control as the only way to stop the forks from fully lowering to the floor is to pulse the pump in the “up” direction.

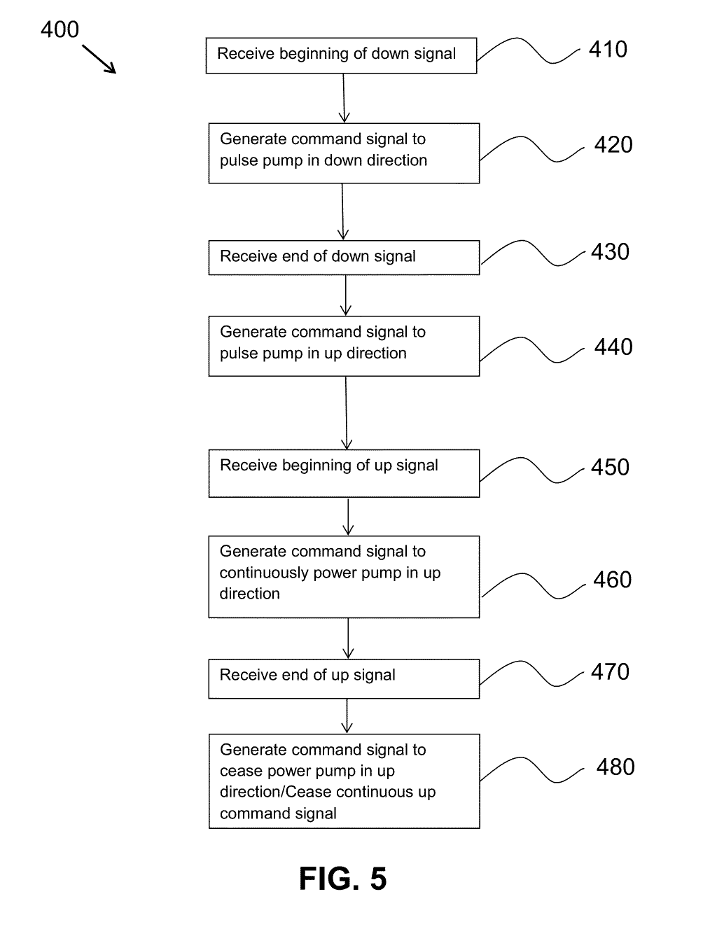

Therefore, an embodiment could include the incorporation of the gravity return function into a controller of the pallet truck in a way that would provide the user maximum control of the pallet truck forks during lowering but also provide for the least amount of energy consumption by the actuator. This embodiment would include a control algorithm whereby the user is required to provide continuous input to lower forks of pallet truck, but the pump is not required to run during entire lowering cycle. As shown in FIG. 5, when the user prompts the pallet truck to lower by depressing a button (or using a joystick or the like) on pallet truck, the controller momentarily powers the pump in the “down” direction allowing for pilot operation of load holding check 324. After initially pulsing the pump in the “down” direction, the controller eliminates the power output to the system and the pilot line check seat 332 maintains adequate pressure to keep the pilot operated load holding check 324 active and lower the forks of the pallet truck. If the user removes the input from the pallet truck the controller prompts the pump to pulse in the “up” direction to relieve pressure in the pilot line and allows the load holding check 324 to hydraulically lock the piston and prevent the forks from further lowering. This embodiment would reduce power consumption of the system while allowing the user better control of the fork height during the lowering cycle.

In more detail, the method 400 at block 410 includes receiving the beginning of a down signal from, for example, a user input. At block 420, a command signal is generated to pulse the pressure source (e.g. a pump) in a down direction. At block 430, the end of a down signal is received. At block 440, a command signal to pulse the pressure source in an up direction is generated.

Starting at block 450, the method shows an exemplary “up” mode which may, of course, occur before or after blocks 410-440 (or not at all). At block 450 a beginning of an up signal is received. At block 460 a command signal to continuously provide pressure (e.g., by operating a pump continuously) in an up direction is generated. At block 470 the end of the up signal is received, and at block 480 a command signal to cease providing pressure (e.g., to stop the pump) is generated.

Although the illustrated method illustrates a specific order of executing functional logic blocks, the order of execution of the blocks may be changed relative to the order shown and/or may be implemented in a state-driven or an object-oriented manner. Also, two or more blocks shown in succession may be executed concurrently or with partial concurrence. Certain blocks also may be omitted. Further these blocks need not be performed by any one component, but may be performed by one or more components. It is understood that all such variations are within the scope of the present invention.

Any of the blocks of the method may be embodied as a set of executable instructions (e.g., referred to in the art as code, programs, or software) that are respectively resident in and executed by the controller. The method may be one or more programs that are stored on respective non-transitory computer readable mediums, such as one or more memory devices (e.g., an electronic memory, a magnetic memory, or an optical memory).

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A hydraulic circuit having an up mode, a static mode, and a down mode comprising:
a pilot-operated load holding check valve positioned between an up side of a hydraulic pump and a first side of a hydraulic actuator, whereby the pilot-operated load holding check valve hydraulically locks the actuator, preventing movement of the actuator by an external load when the circuit is in the static mode;
an orifice positioned between a down side of the hydraulic pump and a reservoir, whereby the orifice generates signal pressure upstream of the orifice to unseat the pilot-operated load holding check valve when the circuit is in the down mode; and
a pilot-operated normally closed valve positioned between the pilot-operated load holding check valve and the reservoir, whereby the pilot-operated normally closed check valve allows flow of fluid from the actuator to the reservoir when the circuit is in the down mode.

2. The hydraulic circuit of claim 1, further comprising:
a flow control valve positioned between the actuator and the reservoir, whereby the flow control valve limits the rate at which fluid exits the actuator when the circuit is in the down mode.

3. The hydraulic circuit of claim 1, wherein the orifice is configured to allow flow to a reservoir while maintaining sufficient pressure to pilot operate the load holding check-valve and the normally closed spool valve when the circuit is in the down mode, thereby minimizing power consumption when a motor powering the circuit is run continually during the down mode.

4. (canceled)

5. The hydraulic circuit of claim 1, further comprising:
a second pilot-operated check valve having an inlet and an outlet, the inlet being fluidly connected between the down side of the pump and the orifice, the outlet being fluidly connected to a pilot portion of the pilot-operated load holding check valve and to a pilot portion of the pilot-operated normally closed valve, whereby the second pilot-operated check valve allows the load holding check valve to remain open without continuous power from a motor during the down mode.

6. The hydraulic circuit of claim 5, further comprising:
a preventer valve fluidly connected between the spool valve and a reservoir configured to prevent flow from the reservoir to the spool valve.

7. The hydraulic circuit of claim 6, wherein the preventer valve is a low pressure relief valve.

8. The hydraulic circuit of claim 7, wherein the low pressure relief valve is sized such that required activation pressure is less than that generated by a minimum load on the cylinder yet sufficient to block flow back to the reservoir, thereby allowing the spool valve to return to a closed position and direct pump flow to the cylinder.

9. (canceled)

9. A method for controlling an actuator, the method comprising:
hydraulically locking the actuator with a pilot-operated load holding check valve, thereby preventing movement of the actuator by an external load;
generating signal pressure upstream of an orifice to unseat the pilot-operated load holding check valve; and
allowing flow of fluid from the actuator to a reservoir by opening a pilot-operated normally closed valve.

10. The method of claim 9, further comprising:
receiving a down command having a beginning and an end;
pulsing a motor in a down direction in response to the beginning of the down command; and
pulsing the motor in an up direction in response to the end of the down command.

11. The method of claim 10, further comprising:
receiving an up command having a beginning and an end;
continuously running the motor in the up direction between the beginning and the end of the up command.

12. The method of claim 9, further comprising:
allowing flow to a reservoir while maintaining sufficient pressure to pilot operate the load holding check-valve and the normally closed spool valve, thereby minimizing power consumption when a motor powering the circuit is run continually during the down mode.

13. The method of claim 9, further comprising:
storing excess hydraulic fluid in a rod side of the actuator.

14. The method of claim 9, further comprising:
keeping pressure in a pilot portion of the pilot-operated load holding check valve and a pilot portion of the pilot-operated normally closed valve via a closed second pilot-operated check valve.

15. The method of claim 9, further comprising:
releasing pressure from a pilot portion of the pilot-operated load holding check valve and a pilot portion of the pilot-operated normally closed valve by opening a second pilot-operated check valve.

16. A vehicle comprising:
a lifting mechanism; and
an integrated electro-hydraulic actuator unit including a cylinder having an output rod and a piston, a manifold, a fluid reservoir, a pump, and a motor.

17. The vehicle of claim 16, wherein the manifold is configured for power-up, continuous gravity-down operation of the cylinder.

18. The vehicle of claim 16, wherein the manifold is configured for power-up, momentary gravity-down operation of the cylinder.

19. The vehicle of claim 16, wherein the manifold includes a hydraulic circuit having:
a pilot-operated load holding check valve positioned between an up side of the pump and a first side of a hydraulic actuator, whereby the pilot-operated load holding check valve hydraulically locks the actuator, preventing movement of the actuator by an external load when the circuit is in the static mode;
an orifice positioned between a down side of the hydraulic pump and a reservoir, whereby the orifice generates signal pressure upstream of the orifice to unseat the pilot-operated load holding check valve when the circuit is in the down mode; and
a pilot-operated normally closed valve positioned between the pilot-operated load holding check valve and the reservoir, whereby the pilot-operated normally closed check valve allows flow of fluid from the actuator to the reservoir when the circuit is in the down mode.

20. The vehicle of claim 16, further comprising a controller configured to perform the method having the steps of:
receiving a down command having a beginning and an end;
pulsing a motor in a down direction in response to the beginning of the down command; and
pulsing the motor in an up direction in response to the end of the down command.

21. The hydraulic circuit of claim 5, wherein the second pilot-operated check valve includes a pilot portion fluidly connected to an up side of the pump.
